(19) United States
(12) Patent Application Publication
(10) Pub. No.: US 2005/0072247 A1
(43) Pub. Date: Apr. 7, 2005

(54) Device for measuring a force; device for measuring a pressure; and pressure sensor

(76) Inventors: Karl-Franz Reinhart, Weinsberg (DE); Christian Doering, Stuttgart (DE); Oliver Stoll, Reutlingen (DE); Michael Knauss, Pliezhausen (DE)

Correspondence Address: KENYON & KENYON, ONE BROADWAY, NEW YORK, NY, 10004, US

(21) Appl. No.: 10/648,505

(22) Filed: Aug. 25, 2003

(30) Foreign Application Priority Data
Aug. 23, 2002 (DE) 102 38 721.4

(51) Int. Cl. G01L 1/00

(52) U.S. Cl. 73/777

(57) ABSTRACT

A device for measuring a force, for example a pressure in a predefined direction, wherein a substrate is provided with a main substrate plane, and the direction is parallel to the main substrate plane.

### FIELD OF THE INVENTION

The present invention relates to a device and a pressure sensor.

### BACKGROUND INFORMATION

At present, pressure sensors or force sensors are known, where a membrane, made, for example, of metal or also, for instance, of semiconductor material, which is provided above a cavity, is deflected by an action of force or by an action of pressure, and the deflection of the membrane is measurable, for instance, by strain gauges. In this connection, a substrate is usually provided which has a main substrate plane, the force to be measured acting on the substrate in a direction perpendicular to the main substrate plane.

### SUMMARY OF THE INVENTION

In contrast, the device of the present invention and the pressure sensor of the present invention, respectively, have the advantage of providing a substrate which has a main substrate plane, the predefined direction of the force measurement being parallel to the main substrate plane. This allows, first of all, for the sensor element of the device according to the present invention to have a smaller configuration, and therefore for the device of the present invention to have an altogether smaller design. Moreover, it is thereby possible to achieve a thermal decoupling or a thermal stress reduction of the sensor element with respect to the location of the measurement.

The possibility of determining a combustion chamber pressure during normal vehicle operation allows new possibilities in engine management. Various useful effects are expected of engine management systems based on combustion-chamber pressure, for example, the reduction of emissions and noise level, particularly for diesel engines. In addition, an online diagnostics of the engine is also desirable for detecting and avoiding engine faults. Because of the extreme conditions in the combustion chamber, conventional mass-produced (high-) pressure sensors are often exerted to their physical limits. Temperatures of more than 1000° C. prevail in the combustion chamber, which may be reduced to below 350° C. at the sensor tip by a thermal coupling to the cylinder wall. The narrowness of the space at the cylinder head of present-day four-valve engines also greatly limits the size of the sensor. Thus, for a two-valve engine, the head of the sensor should already have a diameter of a maximum of 4 mm over an overall length of at least 20 mm. For a four-valve engine, up to 100 mm length and more are in the discussion. Therefore, since many variants are needed, one should be able to freely select the overall length. In the case of a diesel engine, the pressure range to be detected is, at a maximum, 200 bar+approximately 100 bar safety reserve for the burst pressure. Moreover, lateral accelerations up to 30 g act on the cylinder head. For the sake of reliability, it is necessary that the sensor withstand up to 30,000 temperature changes from −40° C. up to 300° C. without degradation or even malfunction. In addition, to optimally utilize the potential of such a sensor, a dynamic resolution up to 20 kHz is required.

At temperatures of up to 350° C., the use of possible electronic transducer principles (piezoelectric, piezoresistive, etc.) is sharply restricted. In particular, conventional electronics based on silicon may no longer be used, since they operate usefully only up to a maximum of 150° C. The use of polysilicon strain gauges or conventional piezoresistors diffused in silicon is therefore not possible. The size restriction and the comparatively small signals attainable prevent the use of metal thin-film sensor elements. Moreover, in practice, a combustion-chamber pressure sensor is not feasible where a rod transmits the displacement of a membrane in or at the combustion chamber to a micromechanical pressure sensor in the cooler region, and thus moves the mechanical-electrical signal conversion out of the hot region at the edge of the combustion chamber to the cooler region, because, based on the necessary dynamics of 20 kHz, one must basically expect a limitation of the rod length and therefore of the overall geometry. In practical terms, the required geometry with a diameter of less than 4 mm over more than 25 mm overall length cannot be realized, since flexural vibrations already occur in such a rod and in the housing at approximately 5 kHz. Therefore, the device of the present invention for measuring a force and for measuring a pressure, and the pressure sensor, respectively, have the advantage of providing an electronic solution for the problem of the combustion-chamber sensor system, it being possible to provide the device of the present invention in the smallest of spaces. By a signal conversion directly at or relatively close to the combustion-chamber membrane, the intention is to circumvent the geometric restriction when using a coupling element, thereby permitting the required multiplicity of variants.

By the use of SOI (silicon on insulator) material, the requirement of temperature stability to over 350° C. is met. This has the advantage that the sensor element may be placed in relatively close proximity to the zone of the pressure to be measured, so that the device is afflicted with fewer errors due to the transfer of pressure from the combustion chamber to the sensor element. By using silicon carbide on insulator as substrate material or as material of the sensor element, it is even possible to thermally load the sensor element up to temperatures of approximately 500° C.

Moreover, it is advantageous that the substrate of the sensor element according to the present invention is installed in a vertical standing manner relative to the measuring area. In this case, vertical is defined as the direction of the force to be measured, i.e. the direction of the force which corresponds to a pressure to be measured, acts parallel to the main plane of the substrate. It is thereby advantageously possible to minimize the necessary installation area; at the same time, there is a contacting possibility from behind, that is to say, a contacting possibility on the side of the membrane lying opposite the combustion chamber. In the design of the present invention, the SOI chip is completely cut through at a defined location, and specifically over the entire wafer thickness. In this manner, a bending bar is formed, accompanied by a vertical design and force coupling parallel to the main substrate plane.

According to the present invention, it is possible to provide the bending bar as a micromechanical bending bar in SOI material for maximum signal yield. The present invention permits the provision of strain resistors in the bending bar.

Furthermore, it is possible to provide a “nose” or different variations thereof for the defined force coupling. This renders possible a device of the present invention with minimal contact area of the silicon chip on the membrane, and therefore minimal temperature transfer between the membrane and the chip. It is also advantageous here that the substrate part situated on the combustion-chamber side has a comparatively high thermal resistance due to the narrowing of the substrate (nose) and the reduced contact area, so that the sensor element is effectively protected against too high a temperature load from sides of the combustion chamber.

Furthermore, especially due to the arrangement of the sensor element, it is possible, if necessary, to also integrate high-temperature-stable evaluation electronics for the primary sensor signals on the SOI sensor chip.

The device and the pressure sensor of the present invention may be produced using standard micromechanical processes, which makes the device less expensive and more robust, particularly also with respect to production tolerances.

The device of the present invention may have monocrystalline silicon for the piezoresistive signal conversion on or in the SOI chip. This makes it possible to realize a high K-factor and—together with the bending-bar arrangement which is more sensitive compared to the force stress of a chip without a substrate cutout—high primary measuring signals. In this manner, the present invention advantageously makes it possible to carry the primary measuring signals over great distances—amplification locally therefore not being necessary. This is advantageous particularly with respect to the multiplicity of variants for long, slender sensor superstructures designs which require carrying the signal over long distances.

Another advantage in the device of the present invention is that small substrate masses and small sensor element masses are used, which is permitted in particular by the use of micromechanics, and thus results in high self-resonant frequencies of considerably greater than 100 kHz.

### BRIEF DESCRIPTION OF THE DRAWINGS

FIG. 1 is a perspective view of a fundamental design of the device of the present invention and the pressure sensor of the present invention.

FIG. 2 is a cross sectional view of a first specific embodiment of the device according to the present invention.

FIG. 3 is a cross sectional view of a second specific embodiment of the device.

FIG. 4 is a cross sectional view of a third specific embodiment of the device.

FIG. 5 is a cross sectional view of a fourth specific embodiment of the device.

FIG. 6 is a section view of a mounting principle of the device.

### DETAILED DESCRIPTION

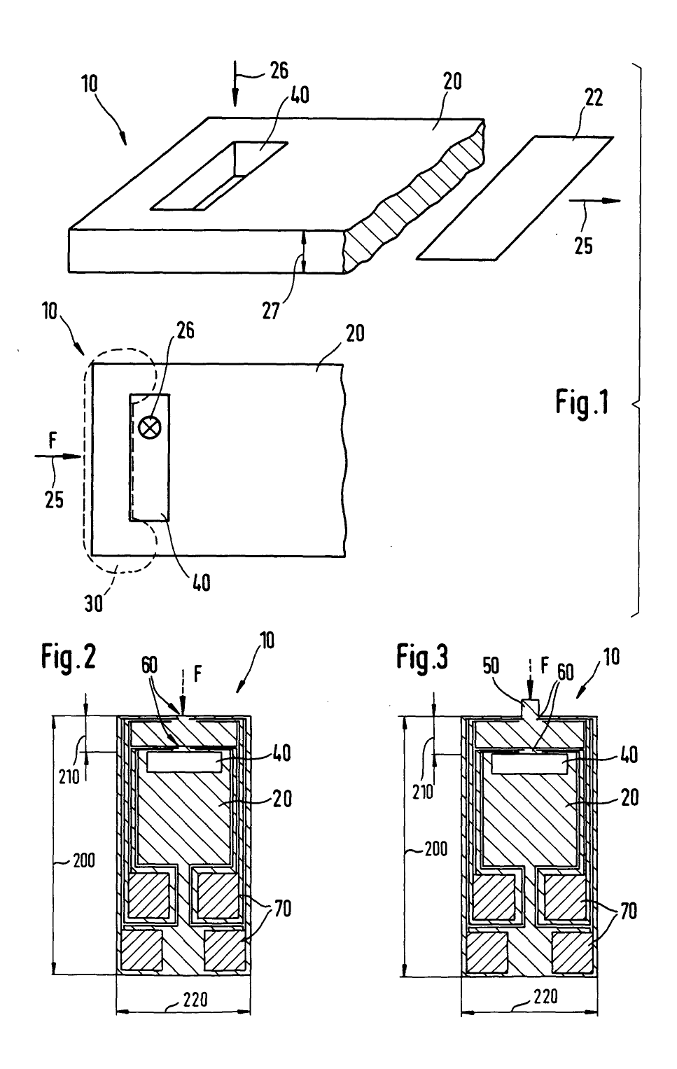

The device of the present invention for measuring a force and for measuring a pressure, respectively, is illustrated in the upper part of FIG. 1 and is provided with reference numeral 10. Device 10 is also illustrated in the lower part of FIG. 1, but in plan view, while it is illustrated in perspective representation in the upper part of FIG. 1. Device 10 of the present invention includes a substrate 20 having a main substrate plane 22. Substrate 20 has a thickness 27, which need not be provided uniformly over the entire substrate surface. Device 10 of the present invention is used for measuring a force, i.e. for measuring a pressure, a measuring area being provided via which the measurement of a pressure may be transferred to a measurement of a force, the force being introduced into sensor element 10 in a predefined direction; the force is provided in FIG. 1 with reference symbol F, and the predefined direction for introducing the force into sensor element 10 is provided in FIG. 1 with reference numeral 25. The device of the present invention differs from known devices for measuring a force or for measuring a pressure, particularly in that predefined direction 25 for introducing force F is provided parallel to main substrate plane 25. To that end, sensor element 10 is provided such that in its substrate 20, a stress zone is provided having reference numeral 30 in the lower part of FIG. 1, and a weakening zone is provided having reference numeral 40 in the lower and upper part of FIG. 1. Stress zone 30 and weakening zone 40 cooperate such that, in response to the introduction of force F in direction 25 into substrate 20, a mechanical stress is introduced in stress zone 30 which, as a rule, mechanically slightly bends stress zone 30. This bending may be measured with the aid of a bending arrangement, e.g. piezoresistors, illustrated in the further figures. To permit stress zone 30 to bend, it is necessary that weakening zone 40 be present, that is to say, that substrate 20 be less resistant in the region of the weakening zone in direction 25 than in the remaining regions. According to the present invention, this weakening of the stability of the sensor element in weakening zone 40 is achieved in particular in that weakening zone 40 has a cutout, the cutout being provided in particular as an opening through entire thickness 27 of substrate 20. Therefore, this cutout or this hole is provided in a direction 26 perpendicular to main substrate plane 22. As can be seen especially from the lower part of FIG. 1, stress zone 30, which is roughly defined with a dotted line in the lower part of FIG. 1, is adjacent to weakening zone 40 in main substrate plane 22. According to the present invention, stress zone 30 is provided in particular at the edge of substrate 20, and weakening zone 40 is located toward the interior of substrate 20, starting from stress zone 30. In the present invention, weakening zone 40 is provided in particular as an essentially rectangular cutout, and especially as a rectangular hole, i.e. as an opening through entire thickness 27 of substrate 20.

FIG. 6 illustrates a pressure sensor 11 of the present invention having a device 10 according to the present invention. In addition to substrate 20, weakening zone 40 and stress zone 30, pressure sensor 11 also has a support 320 for the sensor element. Moreover, pressure sensor 11 of the present invention has a housing 330 and a membrane 310. Housing 330 is provided in particular as an elongated tube into which the sensor element, i.e. substrate 20, secured on support 320 is inserted. Membrane 310 is joined to housing 330 by, for example, welding, adhesive or similar joining techniques. Alternatively, membrane 310 may also be joined in one piece with housing 330. When pressure sensor 11 is used as a combustion-chamber pressure sensor for a combustion engine, membrane 310 borders on the combustion chamber of the combustion engine, and thus transmits the pressure conditions in the combustion chamber, not shown in FIG. 6, to the sensor element or substrate 20. In this context, membrane 310 has a measuring area 311, so that the pressure prevailing in the combustion chamber exerts an action of force onto measuring area 311 in a direction predefined essentially perpendicular to membrane surface 310. This direction of the action of force corresponds to predefined direction 25, discussed in connection with FIG. 1. According to the invention, the action of force onto membrane 310 is transmitted to the sensor element or substrate 20, so that the state of stress in stress zone 30 is available as a measure for the pressure conditions prevailing in the combustion chamber. For transferring the action of force from membrane 310 to the sensor element, the present invention provides in particular, and it is shown in FIG. 6, that a force-introduction element 50 is located between membrane 310 and the sensor element. To insert device 10 on support 320 into housing 330, device 10 is introduced in particular into housing 330 and, preferably under slight prestressing—e.g., approximately 15 N—is put onto membrane 310 which sits on housing 330 and seals the sensor, i.e. device 10 from the combustion chamber. According to the invention, the prestressing is especially necessary to ensure the requisite adhesion between membrane 310 and the sensor or device 10 even at low temperatures. The change in the combustion-chamber pressure causes the membrane to deform, which, via a force-introduction element 50, causes stress zone 30, also designated as micro-bending bar 30, to bend, and therefore an electric signal is generated. It is especially advantageous in the present invention that force-introduction element 50 is provided in such a way that, comparatively, the contact area or joining area between membrane 310 and force-introduction element 50 is particularly small. It is thereby possible that, even given a hot membrane 310 having temperatures, for instance, of over 300° C., considerably lower temperatures are attainable at the sensor element—particularly temperatures below 230° C. In this way, it is possible to safely use an SOI-chip or an SOI-substrate as material of substrate 20 as combustion-chamber pressure sensor 11.

The use of SOI as material for substrate 20 makes it possible to ensure the functionality of an electronic structure to temperatures above 350° C. The mechanical-electrical signal conversion may therefore be performed directly at combustion-chamber membrane 310, which has temperatures of 300° C. and above. Therefore, according to the present invention, it is possible to dispense with a force coupling, e.g. using a rod, over long distances between hot sensor membrane 310 and the location of the mechanical-electrical signal conversion. When using an SOI substrate, monocrystalline silicon is utilized, for example, for the piezoresistive signal conversion of the mechanical stresses in stress zone 30, great signal strengths thereby being obtained. This is advantageous according to the present invention, because the monocrystalline silicon as a piezoresistive layer has a K-factor up to 120. It is thereby possible to attain high sensitivities of up to 1.62 mV per volt and bar. Given this value, at 200 bar, one would accordingly obtain a signal of 324 mV per volt. This has the advantage that signal amplification on the sensor element or on substrate 20 of the sensor element itself is not necessary, even though the possibility exists in principle for integrating electronic functions when working with an SOI substrate. Furthermore, according to the present invention, it is possible to perform additional functions such as data evaluation on SOI substrate 20. Alternatively, and particularly if additional functions are not integrated on substrate 20, the large signals indicated permit lines which transmit the signal to be kept suitably long up to the evaluation unit. This ensures the possibility of a great many variants for the various design forms of a pressure sensor 11 according to the present invention.

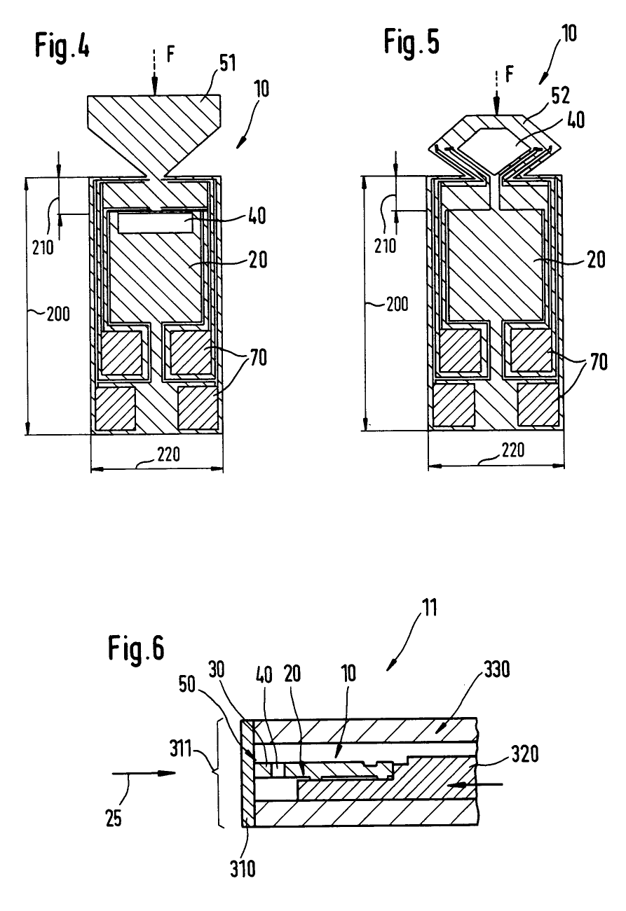

FIGS. 2 through 5 show various micromechanical implementations of device 10 according to the present invention. In each case, the direction of the introduction of force is represented by an arrow and the designation “F”. Moreover, in each case substrate 20 is shown with its weakening zone 40. Piezoresistors 60 are provided on substrate 20 at the locations of the greatest stress in stress zone 30, which, however, is not explicitly mentioned with a reference numeral in FIGS. 2 through 5. According to the invention, piezoresistors 60 are provided in particular as monocrystalline silicon regions in the SOI material of substrate 20, but according to the invention, may also be developed using a different piezoactive material. The piezoresistive elements are no longer explicitly shown in FIGS. 4 and 5. Furthermore, the indicated FIGS. 2-5 are each provided with contact points, in each case in terms of 2 examples, having reference numerals 70. Contact points 70 are connected by lines having a comparatively low ohmic resistance, e.g. metal lines, to piezoresistive elements 60. Contact points 70 are used for tapping off the electric signals caused by piezoresistive regions 60. For example, FIGS. 2 through 5 show width 220 of device 10, length 200 of device 10 and extension 210 of a part of the stress zone. Provided illustratively as measurements are 1.6 mm for width 220 of the device, 3 mm for length 200 of the device and 0.43 mm for extension 210 of the stress zone. However, according to the present invention, these values are only illustrative examples. Also represented in FIGS. 3 through 5 is a force introduction zone or a force introduction element having reference numerals 50, 51, 52. They correspond to various micromechanical implementations of device 10 according to the present invention. All the variants are based on the approach of producing a micro-bending bar, also designated here as stress zone 30, with integrated silicon piezoresistors whose electrical resistance changes in response to bending or mechanical stresses of micro-bending bar 30. In this context, resistors 60 are always to be applied where the greatest mechanical deformations are to be expected in response to bending of the micro-structure. It turns out that the middle of the bar of stress zone 30 is very well suited for this purpose. In addition, according to the present invention, resistors 60 are interconnected in particular to form a Wheatstone bridge, whereby temperature and drift effects may be compensated. The simplest design approach of the present invention is illustrated in FIG. 2 as the first specific embodiment of device 10 according to the invention, where membrane 310 must be formed so that it stresses the bar or stress zone 30 in a defined manner. In the second specific embodiment of device 10 according to the invention illustrated in FIG. 3, this defined introduction of force is already integrated by a force-introduction element 50. Force-introduction element 50 is represented in particular in FIG. 3 as a “nose”, and leads to the bending of the micro-mechanically depicted bar, i.e. stress zone 30, and therefore to the unbalance of the adjusted Wheatstone bridge. The approximate dimensions of the device according to the present invention at 2 to 3 mm are very small by way of example. However, according to the invention, the possibility exists of providing an even smaller device 10. A third specific embodiment of device 10 according to the invention is illustrated in FIG. 4 and includes a modified force-introduction element 51. Force-introduction element 51 in the third specific embodiment of device 10 may essentially be described as a triangle whose tip points at a defined location of stress zone 30, and whose base is in contact with membrane 310. In this context, the third specific embodiment of device 10 according to the present invention provides force-introduction element 51 with a “cut-off” tip of the triangle and an extension of the base of the triangle in the direction of membrane 310. Alternatively, force-introduction element 51 may also be described as a wedge whose tip points at stress zone 30. Force-introduction elements 50, 51 are provided in particular in the form of a tapering of substrate 20, so that the introduction of force is able to be better defined and localized. Moreover, such a tapering of the substrate makes it advantageously possible to better thermally decouple the substrate region in which the piezoresistors or generally the measuring elements are located, from the region of membrane 310, because the heat conduction is less via the tapered region of force- introduction element 50, 51. In a fourth specific embodiment of device 10 according to the present invention shown in FIG. 5, instead of a bending bar, a flat-spring-type structure 52 is used as stress zone 30, into which the piezoresistors are integrated. Flat-spring-type structure 52 includes essentially four sides, and may also be called a diamond-shaped structure whose one “corner” is integrally joined with the substrate, whose corner of the diamond opposite this one corner is used as a force-introduction element, and whose other two comers have the regions which accommodate the piezoresistors. According to the present invention, the corner used as the force-introduction element is provided in particular in a flattened fashion. Cutout 40 is provided inside the diamond, so that flat-spring-type structure 52 includes stress zone 30, cutout 40 and the force-introduction element.

In FIGS. 2 through 5, metallic contact pads 70 are provided for the contacting of the Wheatstone bridge. In the case of an evaluation circuit integrated on substrate 20, contact pads 70 are used for picking off the completely amplified N-signals. Substrate 20 is held by support 320. In this context, the fixation may be effected at the end stop using suitable clamping, or by a joining technique such as glazing over. The electrical connection to the contact pads may be implemented, for example, by wire bonding, by thermo-compression bonding or by welding.

According to the present invention, the bonding pads and the connection leads of contact pads 70 to piezoresistive resistors 60 are provided in particular as metallized regions.

In the present invention, a deformation in the middle of approximately 3.7 μm is provided in particular as the maximum bending of stress zone 30. The stresses in the middle of the bar are approximately equal and in opposite direction on the force-introduction side and the cutout side in FIGS. 2 through 4. Therefore, the middle of the bar is suitable for the placement of piezoresistive resistors 60.

1. A device for measuring a force in a predefined direction, comprising:
a sensor element, the sensor element including a substrate having a main substrate plane, wherein the predefined direction of force measurement is parallel to the main substrate plane.

2. The device according to claim 1, wherein the substrate includes a cutout in a direction perpendicular to the main substrate plane.

3. A device for measuring a force, comprising:
a sensor element, the sensor element having a substrate, the substrate having a main substrate plane, wherein the sensor element has a stress zone and a weakening zone, the stress zone being provided over an entire thickness of the substrate perpendicular to the main substrate plane, and the weakening zone being provided over the entire thickness of the substrate perpendicular to the main substrate plane.

4. The device according to claim 3, wherein the stress zone and the weakening zone are adjacent in the main substrate plane.

5. The device according to claim 3, wherein the weakening zone is provided as a cutout in the substrate in a direction perpendicular to the main substrate plane.

6. The device according to claim 5, wherein the cutout is provided through the entire thickness of the substrate perpendicular to the main substrate plane.

7. The device according to claim 5, wherein the cutout is configured as a hole through the substrate in a direction perpendicular to the main substrate plane.

8. The device according to claim 5, wherein the cutout is configured as a rectangle.

9. The device according to claim 3, wherein the stress zone is provided at an edge of the substrate.

10. The device according to claim 3, further comprising:
a force-introduction element arranged at the stress zone, the force-introduction element being integrally joined with the substrate.

11. The device according to claim 10, wherein the force-introduction element is provided as one of a tapering, a wedge, a triangle, and a flat-spring-type structure which includes the stress zone, the cutout and the force-introduction element.

12. The device according to claim 10, wherein the force-introduction element is provided in a middle of the stress zone.

13. The device according to claim 3, wherein the substrate is provided from a semiconductor material.

14. The device according to claim 3, wherein the substrate is provided at least one of in a partial area as silicon on insulator material and as silicon carbide on insulator material.

15. The device according to claim 3, wherein at least one of the sensor element is provided as a micromechanical sensor element and integrated evaluation electronics are provided on the substrate.

16. The device according to claim 1, further comprising:
a measuring area, wherein the pressure is measured via a measurement of a pressure force onto the measuring area.

17. The device according to claim 3, wherein the device is configured as a pressure sensor.
